(19) United States
(12) Patent Application Publication
(10) Pub. No.: US 2019/0273577 A1
(43) Pub. Date: Sep. 5, 2019

(54) SELF-SYNCHRONIZING VITERBI DECODER

(71) Applicant: QUALCOMM Incorporated, San Diego, CA (US)

(72) Inventors: Eunmo KANG, San Diego, CA (US); Anand Srinivas GURUSWAMY, San Diego, CA (US); Le LUONG, San Diego, CA (US)

(21) Appl. No.: 16/031,804

(22) Filed: Jul. 10, 2018

Related U.S. Application Data
(60) Provisional application No. 62/638,864, filed on Mar. 5, 2018.

(51) Int. Cl. H04L 1/00; H04L 12/721

(52) U.S. Cl. CPC H04L 1/0054; H04L 45/14

(57) ABSTRACT

In an aspect of the disclosure, a method, a computer-readable medium, and an apparatus are provided. The apparatus may receive a data packet that includes at least in part a preamble, an encoded block, and a payload. The apparatus may detect the preamble of the data packet at a last symbol of the preamble or prior to the last symbol of the preamble. The apparatus may compute a branch metric for each of a plurality of transitions between states. The apparatus may initialize a path metric for each of a plurality of non-synchronization states and synchronization states. In certain aspects, each of the synchronization states may be associated with the preamble. The apparatus may determine a survivor path for each of the non-synchronization states and synchronization states based at least in part on a respective path metric. The apparatus may determine a traceback timing.

### CROSS-REFERENCE TO RELATED APPLICATION(S)

This application claims the benefit of U.S. Provisional Application Ser. No. 62/638,864, entitled “SELF-SYNCHRONIZING VITERBI DECODER” and filed on Mar. 5, 2018, which is expressly incorporated by reference herein in its entirety.

### BACKGROUND

### Field

The present disclosure relates generally to communication systems, and more particularly, to a self-synchronizing Viterbi decoder.

### Background

A wireless personal area network (WPAN) is a personal, short-range wireless network for interconnecting devices centered around a specific distance from a user. WPANs have gained popularity because of the flexibility and convenience in connectivity that WPANs provide. WPANs, such as those based on short-range communication protocols (e.g., a Bluetooth® (BT) protocol, a Bluetooth® Low Energy (BLE) protocol, a Zigbee® protocol, etc.), provide wireless connectivity to peripheral devices by providing wireless links that allow connectivity within a specific distance (e.g., 5 meters, 10 meter, 20 meters, 100 meters, etc.).

BT is a short-range wireless communication protocol that supports a WPAN between a central device (e.g., a master device) and at least one peripheral device (e.g., a slave device). Power consumption associated with BT communications may render BT impractical in certain applications, such as applications in which an infrequent transfer of data occurs.

To address the power consumption issue associated with BT, BLE was developed and adopted in various applications in which an infrequent transfer of data occurs. BLE exploits the infrequent transfer of data by using a low duty cycle operation, and switching at least one of the central device and/or peripheral device(s) to a sleep mode in between data transmissions. A BLE communications link between two devices may be established using, e.g., hardware, firmware, host operating system, host software stacks, and/or host application support. Example applications that use BLE include battery-operated sensors and actuators in various medical, industrial, consumer, and fitness applications. BLE may be used to connect devices such as BLE enabled smart phones, tablets, and laptops. While traditional BLE offers certain advantages, there exists a need for further improvements in BLE technology.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may receive a data packet that includes at least in part a preamble, an encoded block, and a payload. The apparatus may detect the preamble of the data packet at a last symbol of the preamble or prior to the last symbol of the preamble. The apparatus may compute a branch metric for each of a plurality of transitions between states. The apparatus may initialize a path metric for each of a plurality of non-synchronization states and a plurality of synchronization states when the preamble is detected. In certain aspects, each of the plurality of synchronization states may be associated with the preamble. The apparatus may determine a survivor path for each of the plurality of non-synchronization states and for each of the plurality of synchronization states based at least in part on a respective path metric. The apparatus may determine a traceback timing based at least in part on when the survivor path for each of the plurality of non-synchronization states was last in the preamble.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a WPAN in accordance with certain aspects of the disclosure.

FIG. 2 is block diagram of a wireless device in accordance with certain aspects of the disclosure.

FIG. 3 is a diagram illustrating a modified BLE protocol stack in accordance with certain aspects of the disclosure.

FIG. 4 is a diagram illustrating a BLE data packet in accordance with certain aspects of the disclosure.

FIG. 5A illustrates a packet acquisition subsystem that includes a Viterbi Decoder and a more detailed illustration of the Viterbi Decoder in accordance with certain aspects of the disclosure.

FIG. 5B illustrates a trellis diagram associated with a convolutional code used by a convolutionally encoded BLE data packets in accordance with certain aspects of the disclosure.

FIG. 5C illustrates a packet acquisition subsystem that includes a self-synchronizing Viterbi Decoder in accordance with certain aspects of the present disclosure.

FIG. 5D illustrates a more detailed illustration of a self-synchronizing Viterbi Decoder in accordance with certain aspects of the disclosure.

FIG. 5E illustrates a trellis diagram associated with a convolutional code used by convolutionally encoded BLE data packet that includes both regular states (e.g., non-synchronization states) and synchronization states in accordance with certain aspects of the disclosure.

FIGS. 6A and 6B are a flowchart of a method of wireless communication.

FIG. 7 is a conceptual data flow diagram illustrating the data flow between different means/components in an exemplary apparatus.

FIG. 8 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

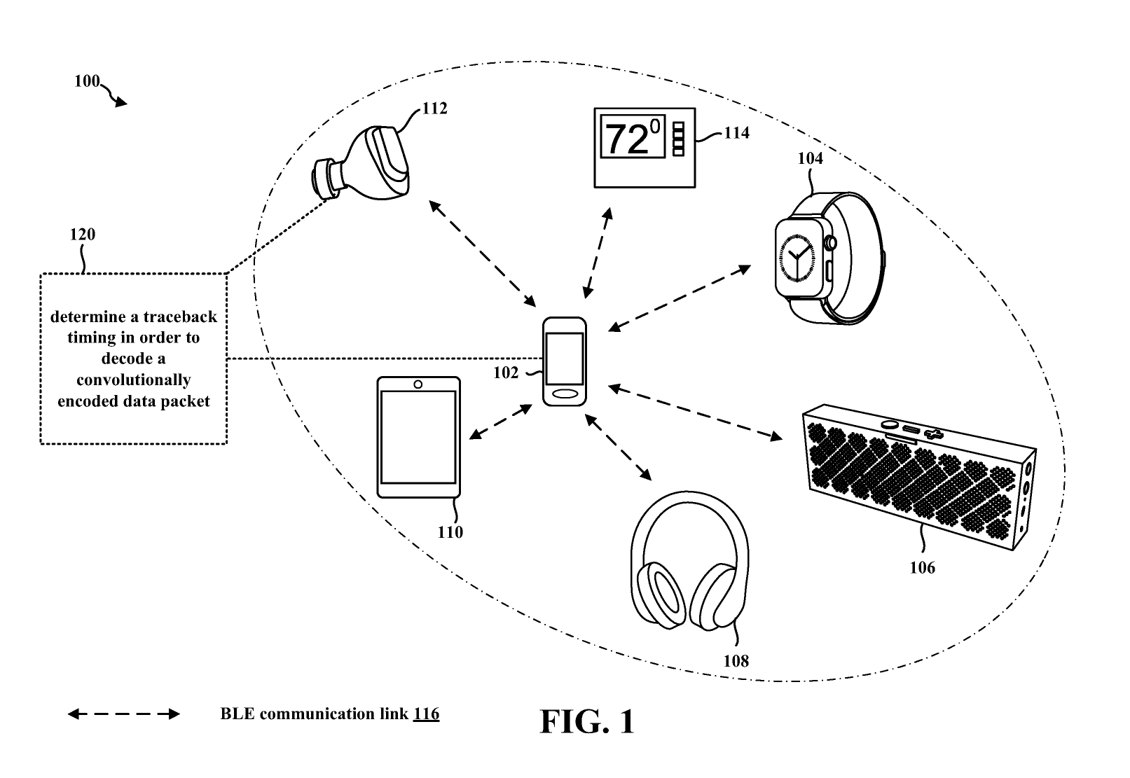

FIG. 1 illustrates an example WPAN 100 in accordance with certain aspects of the disclosure. Within the WPAN 100, a central device 102 may connect to and establish a BLE communication link 116 with one or more peripheral devices 104, 106, 108, 110, 112, 114 using a BLE protocol or a modified BLE protocol. The BLE protocol is part of the BT core specification and enables radio frequency communication operating within the globally accepted 2.4 GHz Industrial, Scientific & Medical (ISM) band.

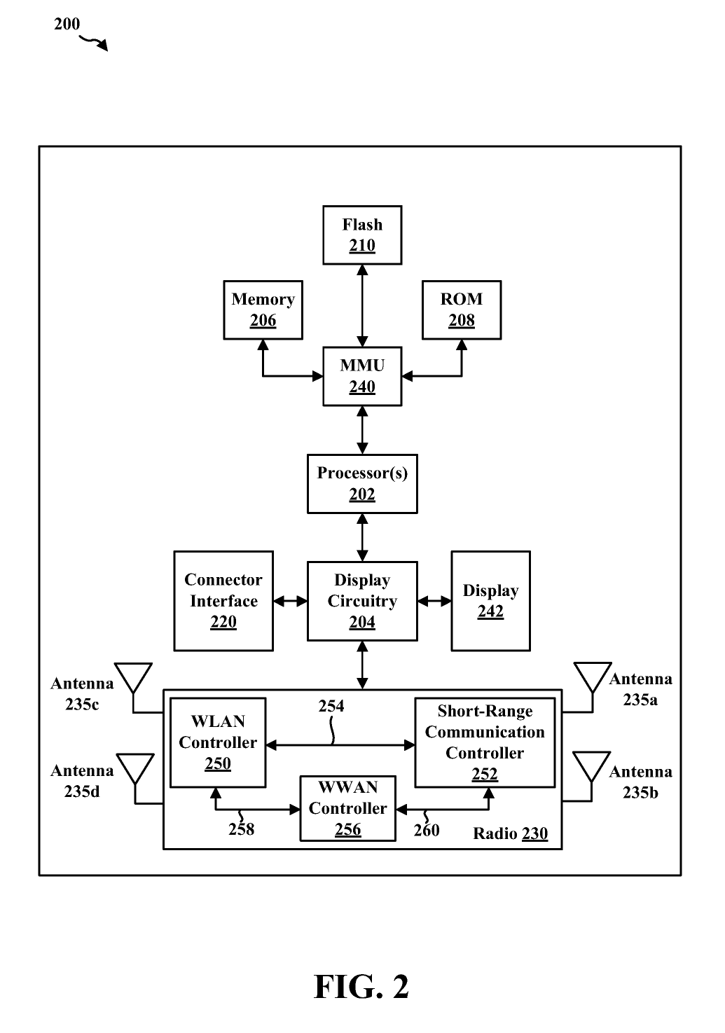

The central device 102 may include suitable logic, circuitry, interfaces, processors, and/or code that may be used to communicate with one or more peripheral devices 104, 106, 108, 110, 112, 114 using the BLE protocol or the modified BLE protocol as described below in connection with any of FIGS. 2-8. The central device 102 may operate as an initiator to request establishment of a link layer (LL) connection with an intended peripheral device 104, 106, 108, 110, 112, 114.

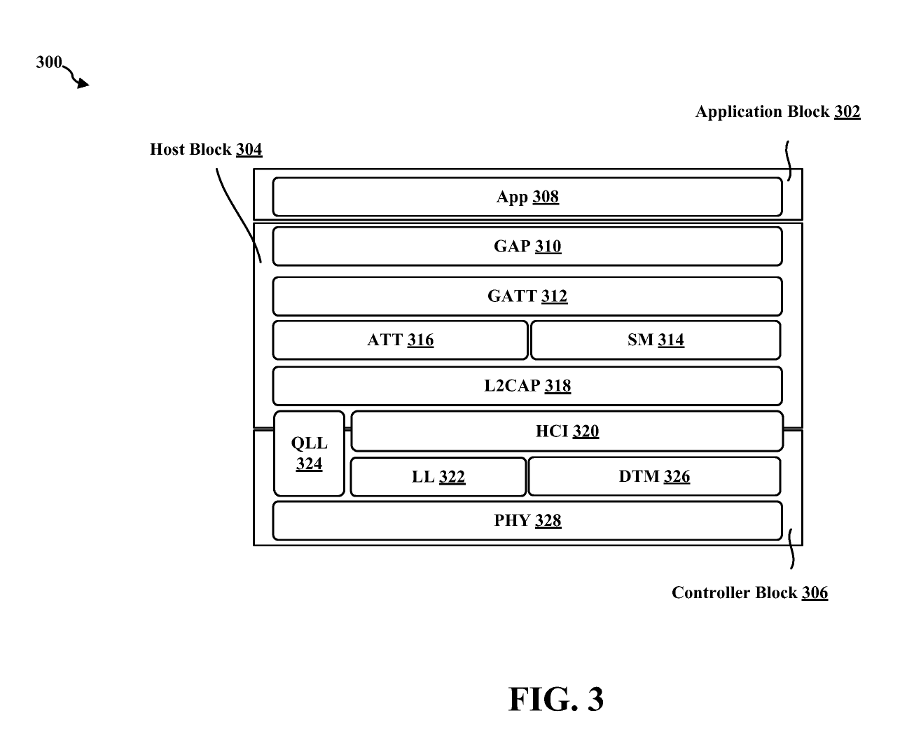

A LL in the BLE protocol stack and/or modified BLE protocol stack (e.g., see FIG. 3) provides, as compared to BT, ultra-low power idle mode operation, simple device discovery and reliable point-to-multipoint data transfer with advanced power-save and encryption functionalities. After a requested LL connection is established, the central device 102 may become a master device and the intended peripheral device 104, 106, 108, 110, 112, 114 may become a slave device for the established LL connection. As a master device, the central device 102 may be capable of supporting multiple LL connections at a time with various peripheral devices 104, 106, 108, 110, 112, 114 (slave devices). The central device 102 (master device) may be operable to manage various aspects of data packet communication in a LL connection with an associated peripheral device 104, 106, 108, 110, 112, 114 (slave device). For example, the central device 102 may be operable to determine an operation schedule in the LL connection with a peripheral device 104, 106, 108, 110, 112, 114. The central device 102 may be operable to initiate a LL protocol data unit (PDU) exchange sequence over the LL connection. LL connections may be configured to run periodic connection events in dedicated data channels. The exchange of LL data PDU transmissions between the central device 102 and one or more of the peripheral devices 104, 106, 108, 110, 112, 114 may take place within connection events.

In certain configurations, the central device 102 may be configured to transmit the first LL data PDU in each connection event to an intended peripheral device 104, 106, 108, 110, 112, 114. In certain other configurations, the central device 102 may utilize a polling scheme to poll the intended peripheral device 104, 106, 108, 110, 112, 114 for a LL data PDU transmission during a connection event. The intended peripheral device 104, 106, 108, 110, 112, 114 may transmit a LL data PDU upon receipt of packet LL data PDU from the central device 102. In certain other configurations, a peripheral device 104, 106, 108, 110, 112, 114 may transmit a LL data PDU to the central device 102 without first receiving a LL data PDU from the central device 102.

Examples of the central device 102 may include a cellular phone, a smart phone, a session initiation protocol (SIP) phone, a mobile station (STA), a laptop, a personal computer (PC), a desktop computer, a personal digital assistant (PDA), a satellite radio, a global positioning system, a multimedia device, a video device, a digital audio player (e.g., MP3 player), a camera, a game console, a tablet, a smart device, a wearable device (e.g., smart watch, wireless headphones, etc.), a vehicle, an electric meter, a gas pump, a toaster, a thermostat, a hearing aid, a blood glucose on-body unit, an Internet-of-Things (IoT) device, or any other similarly functioning device.

Examples of the one or more peripheral devices 104, 106, 108, 110, 112, 114 may include a cellular phone, a smart phone, a SIP phone, a STA, a laptop, a PC, a desktop computer, a PDA, a satellite radio, a global positioning system, a multimedia device, a video device, a digital audio player (e.g., MP3 player), a camera, a game console, a tablet, a smart device, a wearable device (e.g., smart watch, wireless headphones, etc.), a vehicle, an electric meter, a gas pump, a toaster, a thermostat, a hearing aid, a blood glucose on-body unit, an IoT device, or any other similarly functioning device. Although the central device 102 is illustrated in communication with six peripheral devices 104, 106, 108, 110, 112, 114 in the WPAN 100, the central device 102 may communicate with more or fewer than six peripheral devices within the WPAN 100 without departing from the scope of the present disclosure.

Referring again to FIG. 1, in certain aspects, the central device 102 and/or the peripheral device 104, 106, 108, 110, 112, 114 may be configured to determine a traceback timing in order to decode a convolutionally encoded data packet (120), e.g., as described below in connection with any of FIGS. 2-8.

FIG. 2 is block diagram of a wireless device 200 in accordance with certain aspects of the disclosure. The wireless device 200 may correspond to, e.g., the central device 102, and/or one of peripheral devices 104, 106, 108, 110, 112, 114 described above in connection with FIG. 1. In certain aspects, the wireless device 200 may be a BLE enabled device.

As shown in FIG. 2, the wireless device 200 may include a processing element, such as processor(s) 202, which may execute program instructions for the wireless device 200. The wireless device 200 may also include display circuitry 204 which may perform graphics processing and provide display signals to the display 242. The processor(s) 202 may also be coupled to memory management unit (MMU) 240, which may be configured to receive addresses from the processor(s) 202 and translate the addresses to address locations in memory (e.g., memory 206, ROM 208, Flash memory 210) and/or to address locations in other circuits or devices, such as the display circuitry 204, radio 230, connector interface 220, and/or display 242. The MMU 240 may be configured to perform memory protection and page table translation or set up. In some embodiments, the MMU 240 may be included as a portion of the processor(s) 202.

As shown, the processor(s) 202 may be coupled to various other circuits of the wireless device 200. For example, the wireless device 200 may include various types of memory, a connector interface 220 (e.g., for coupling to the computer system), the display 242, and wireless communication circuitry (e.g., for Wi-Fi, BT, BLE, cellular, etc.). The wireless device 200 may include a plurality of antennas 235a, 235b, 235c, 235d, for performing wireless communication with, e.g., wireless devices in a WPAN.

In certain aspects, the wireless device 200 may include hardware and software components (a processing element) configured to determine a traceback timing in order to decode a convolutionally encoded data packet, e.g., using the techniques described below in connection with any FIGS. 3-8. The wireless device 200 may also comprise BT and/or BLE firmware or other hardware/software for controlling BT and/or BLE operations.

The wireless device 200 may be configured to implement part or all of the techniques described below in connection with any of FIGS. 3-8, e.g., by executing program instructions stored on a memory medium (e.g., a non-transitory computer-readable memory medium) and/or through hardware or firmware operation. In other embodiments, the techniques described below in connection with any of FIGS. 3-8 may be at least partially implemented by a programmable hardware element, such as an field programmable gate array (FPGA), and/or an application specific integrated circuit (ASIC).

In certain aspects, radio 230 may include separate controllers configured to control communications for various respective radio access technology (RAT) protocols. For example, as shown in FIG. 2, radio 230 may include a WLAN controller 250 configured to control WLAN communications, a short-range communication controller 252 configured to control short-range communications, and a WWAN controller 256 configured to control WWAN communications. In certain aspects, the wireless device 200 may store and execute a WLAN software driver for controlling WLAN operations performed by the WLAN controller 250, a short-range communication software driver for controlling short-range communication operations performed by the short-range communication controller 252, and/or a WWAN software driver for controlling WWAN operations performed by the WWAN controller 256.

In certain implementations, a first coexistence interface 254 (e.g., a wired interface) may be used for sending information between the WLAN controller 250 and the short-range communication controller 252. In certain other implementations, a second coexistence interface 258 may be used for sending information between the WLAN controller 250 and the WWAN controller 256. In certain other implementations, a third coexistence interface 260 may be used for sending information between the short-range communication controller 252 and the WWAN controller 256.

In some aspects, one or more of the WLAN controller 250, the short-range communication controller 252, and/or the WWAN controller 256 may be implemented as hardware, software, firmware or some combination thereof.

In certain configurations, the WLAN controller 250 may be configured to communicate with a second device in a WPAN using a WLAN link using all of the antennas 235a, 235b, 235c, 235d. In certain other configurations, the short-range communication controller 252 may be configured to communicate with at least one second device in a WPAN using one or more of the antennas 235a, 235b, 235c, 235d. In certain other configurations, the WWAN controller 256 may be configured to communicate with a second device in a WPAN using all of the antennas 235a, 235b, 235c, 235d. The short-range communication controller 252 may be configured to determine a traceback timing in order to decode a convolutionally encoded data packet.

FIG. 3 illustrates a modified BLE protocol stack 300 that may be implemented in a BLE device in accordance with certain aspects of the present disclosure. For example, the modified BLE protocol stack 300 may be implemented by, e.g., one or more of processor(s) 202, memory 206, Flash memory 210, ROM 208, the radio 230, and/or the short-range communication controller 252 illustrated in FIG. 2.

Referring to FIG. 3, the modified BLE protocol stack 300 may be organized into three blocks, namely, the Application block 302, the Host block 304, and the Controller block 306. Application block 302 may be a user application which interfaces with the other blocks and/or layers of the modified BLE protocol stack 300. The Host block 304 may include the upper layers of the modified BLE protocol stack 300, and the Controller block 306 may include the lower layers of the modified BLE protocol stack 300.

The Host block 304 may communicate with a controller (e.g., short-range communication controller 252 in FIG. 2) in a wireless device using a Host Controller Interface (HCl) 320. The HCl 320 may also be used to interface the Controller block 306 with the Host block 304. Interfacing the Controller block 306 and the Host block 304 may enable a wide range of Hosts to interface with the Controller block 306.

The Application block 302 may include a higher-level Application Layer (App) 308, and the modified BLE protocol stack 300 may run under the App 308. The Host block 304 may include a Generic Access Profile (GAP) 310, a Generic Attribute Protocol (GATT) 312, a Security Manager (SM) 314, an Attribute Protocol (ATT) 316, and a Logical Link Control and Adaptation Protocol (L2CAP) 318, each of which are described in further detail below. The Controller block 306 may include a LL 322, a proprietary LL (QLL) 324, a Direct Test Mode (DTM) 326, and a Physical Layer (PHY) 328, each of which are described in further detail below.

To support future applications (e.g., loT applications, audio applications, etc.), the PHY 328 of the present disclosure may support an increased range of communication and data rate as compared to the PHY in a traditional BLE protocol stack. The PHY 328 may define the mechanism for transmitting a bit stream over a physical link that connects BLE devices. The bit stream may be grouped into code words or symbols, and converted to a PDU that is transmitted over a transmission medium. The PHY 328 may provide an electrical, mechanical, and procedural interface to the transmission medium. The shapes and properties of the electrical connectors, the frequency band used for transmission, the modulation scheme, and similar low-level parameters may be specified by the PHY 328.

The DTM 326 may allow testing of the PHY 328 by transmitting and receiving sequences of test packets. DTM 326 may be used in compliance and production-line testing without the need of going through the entire modified BLE protocol stack 300. In other words, the DTM 326 may skip the Host block 304 and communicate directly with the short-range communications controller of the radio (e.g., the short-range communication controller 252 and radio 230 in FIG. 2) in an isolated manner.

The LL 322 may be responsible for low level communication over the PHY 328. The LL 322 may manage the sequence and timing of transmitted and received LL data PDUs, and using a LL protocol, communicate with other devices regarding connection parameters and data flow control. The LL 322 may provide gate keeping functionality to limit exposure and data exchange with other devices. If filtering is configured, the LL 322 may maintain a list of allowed devices and ignore all requests for data PDU exchange from devices not on the list. The LL 322 may use the HCl 320 to communicate with upper layers of the modified BLE protocol stack 300. In certain aspects, the LL 322 may be used to generate a LL data PDU and/or an empty packet (e.g., empty PDU) that may be transmitted using a LL communication link established with another BLE device using the LL 322.

The QLL 324 is a proprietary protocol that exists alongside the LL 322. The QLL 324 may be used to discover peer proprietary devices, and establish a secure communication channel therewith. For example, the QLL 324 may be used to establish a QLL communication link between short-range communication controllers and/or proprietary controllers (not shown in FIG. 2) in two wireless devices, e.g., two Qualcomm® devices, two Apple® devices, two Samsung® devices, etc. The proprietary controllers in peer proprietary devices may communicate with each other using allocated channels, a control protocol, attributes, and procedures. Proprietary controllers may either establish a QLL communication link after a standard connection at the LL 322 has been established or over an advertising bearer. Once a QLL communication link has been established at the QLL 324, the proprietary controllers of two peer proprietary devices may be able to communicate with each other using a set of dedicated channels. Each service available at a proprietary controller may be associated with a particular channel number. A proprietary controller may include up to or more than, e.g., 127 different services. The services may include, e.g., firmware updates, licensing additional codes, and/or adding additional firmware components on peer devices just to name a few.

The L2CAP 318 may encapsulate multiple protocols from the upper layers into a LL data PDU and/or a QLL establishment PDU (and vice versa). The L2CAP 318 may also break large LL data PDUs and/or a QLL establishment PDUs from the upper layers into segments that fit into a maximum payload size (e.g., 27 bytes) on the transmit side. Similarly, the L2CAP 318 may receive multiple LL data PDUs and/or QLL establishment PDUs that have been segmented, and the L2CAP 318 may combine the segments into a single LL data PDU and/or a QLL establishment PDU that may be sent to the upper layers.

The ATT 316 may be a client/server protocol based on attributes associated with a BLE device configured for a particular purpose (e.g., monitoring heart rate, monitoring temperature, broadcasting advertisements, etc.). The attributes may be discovered, read, and written by other BLE enabled devices. The set of operations which are executed over ATT 316 may include, but are not limited to, error handling, server configuration, find information, read operations, write operations, queued writes, etc. The ATT 316 may form the basis of data exchange between BLE devices.

The SM 314 may be responsible for device pairing and key distribution. A security manager protocol implemented by the SM 314 may define how communications with the SM of a counterpart BLE deice are performed. The SM 314 may provide additional cryptographic functions that may be used by other components of the modified BLE protocol stack 300. The architecture of the SM 314 used in BLE may be designed to minimize recourse requirements for peripheral devices by shifting work to a central device. The SM 314 provides a mechanism to not only encrypt the data but also to provide data authentication.

The GATT 312 describes a service framework using the attribute protocol for discovering services, and for reading and writing characteristic values on a counterpart BLE device. The GATT 312 interfaces with the App 308 through the App's profile. The App 308 profile defines the collection of attributes and any permission associated with the attributes to be used in BLE communications. One of the benefits of BT technology is device interoperability. To assure interoperability, using a standardized wireless protocol to transfer bytes of information may be inadequate, and hence, sharing data representation levels may be needed. In other words, BLE devices may send or receive data in the same format using the same data interpretation based on intended device functionality. The attribute profile used by the GATT 312 may act as a bridge between the modified BLE protocol stack and the application and functionality of the BLE device (e.g., at least from a wireless connection point of view), and is defined by the profile.

The GAP 310 may provide an interface for the App 308 to initiate, establish, and manage connection with counterpart BLE devices.

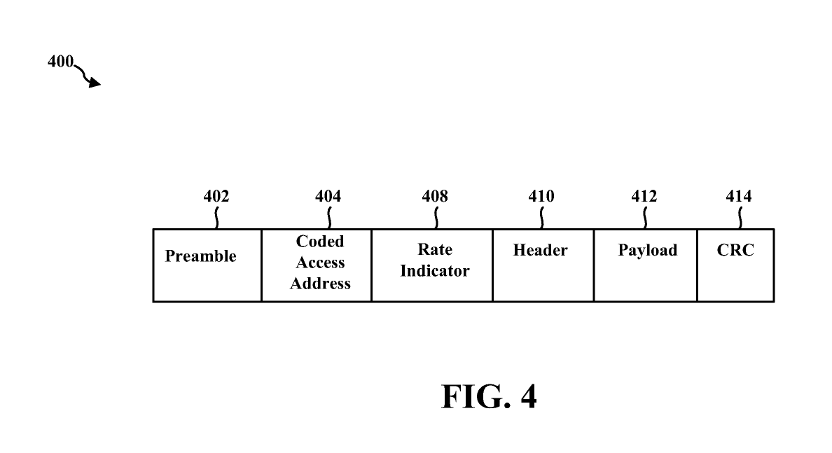

FIG. 4 is a diagram illustrating a convolutionally coded data packet 400 in accordance with certain aspects of the present disclosure. As seen in FIG. 4, the data packet 400 may include a preamble 402, a coded access address 404, a rate indicator 408 (e.g., coding indicator), a header 410, a payload 412, and a CRC 414. In certain configurations, one or more of the coded access address 404 and/or the rate indicator 408 may be convolutionally coded and be referred to as the “encoded block” of the convolutionally coded data packet 400.

In certain configurations, the data packet 400 may not include the CRC 414. In certain other configurations, the payload 412 may include a message integrity check (MIC). An MIC includes information that may be used by to authenticate a data packet. In other words, the MIC may be used by the receiving device to confirm that the message came from the stated transmitting device (e.g., data packet authenticity), and to confirm that the payload 412 has not been changed (e.g., data packet integrity). The MIC protects both payload integrity and the authenticity of the data packet 400 by enabling a receiving device who also possesses the secret key to detect any changes to the payload 412.

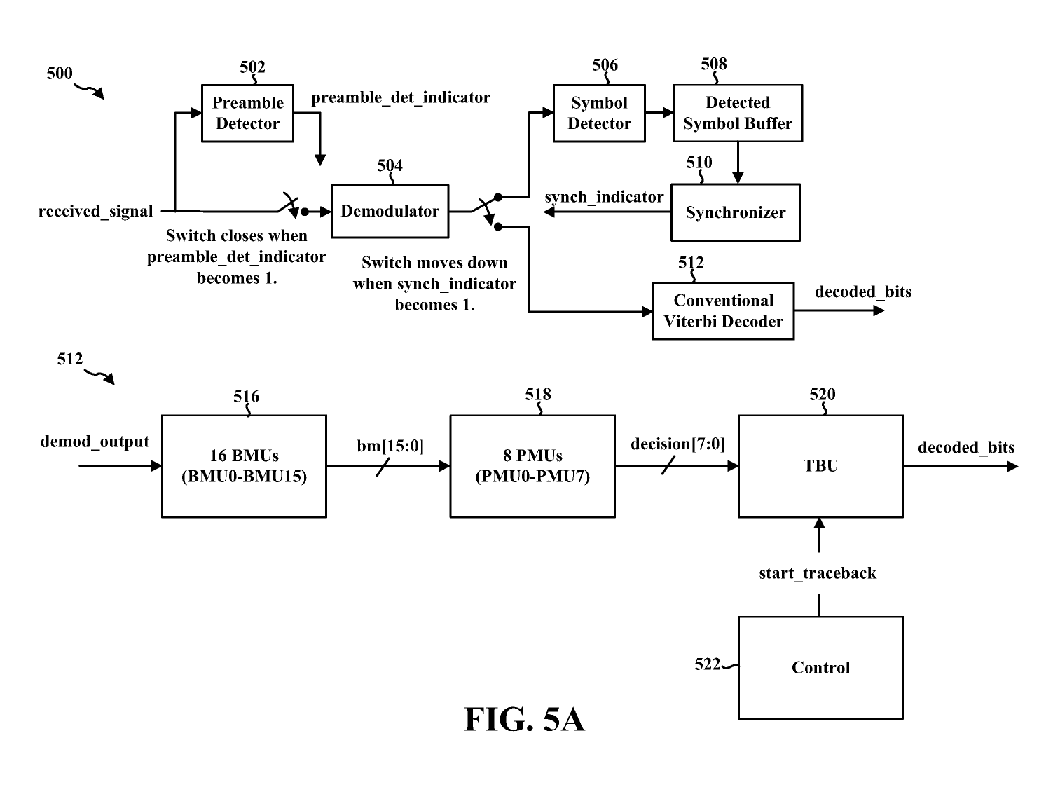

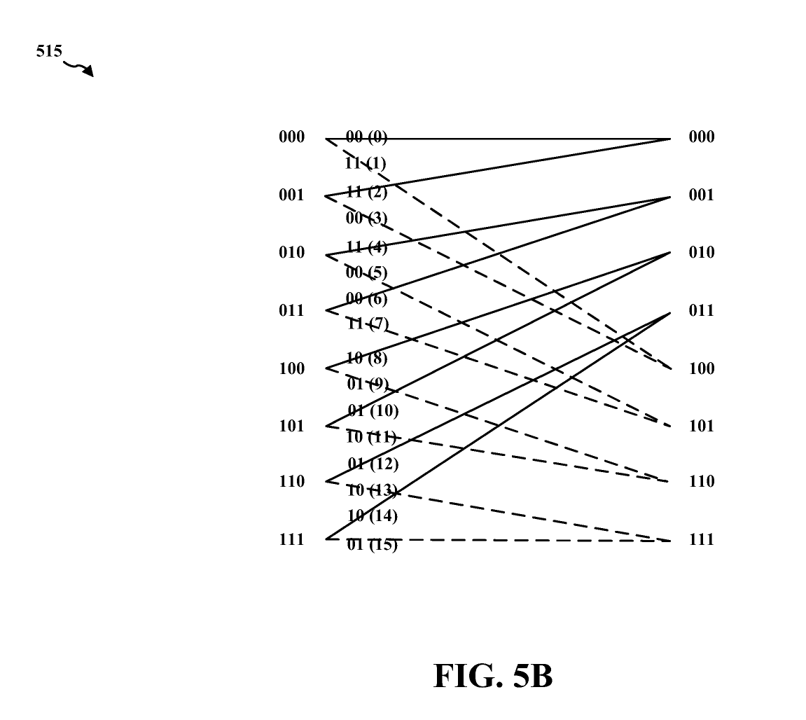

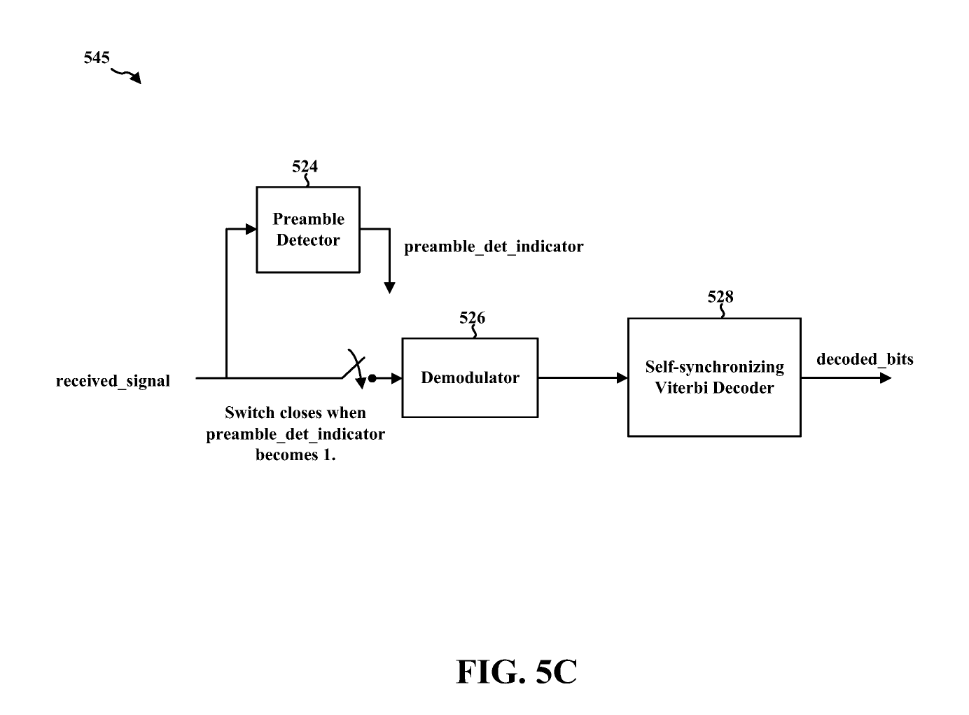

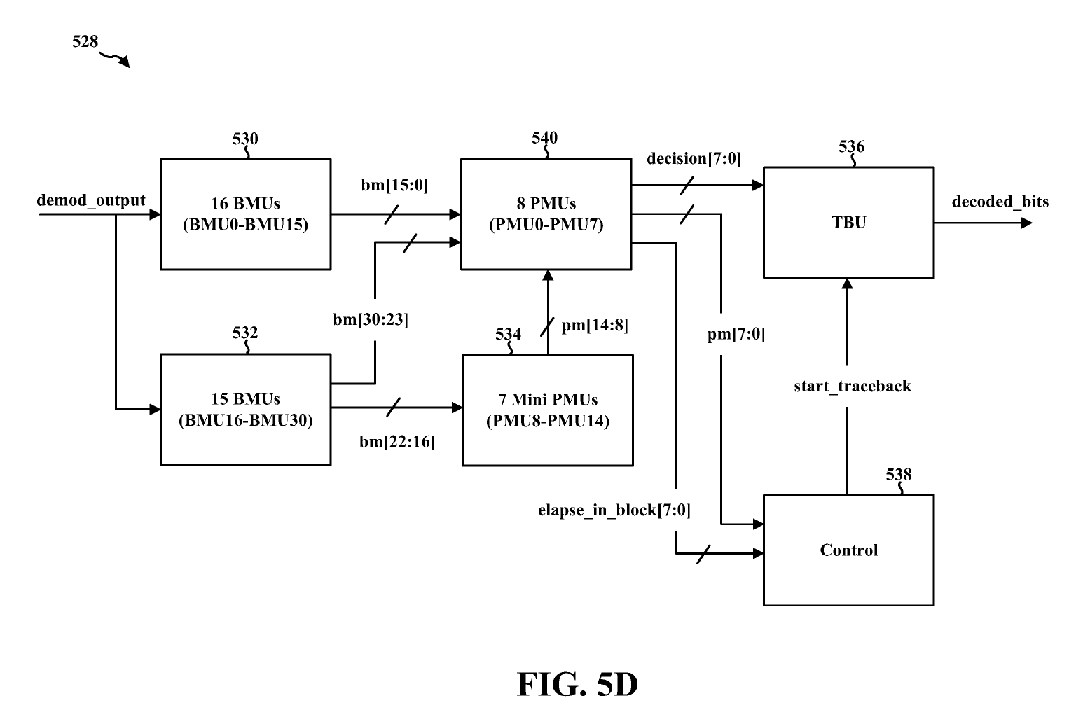

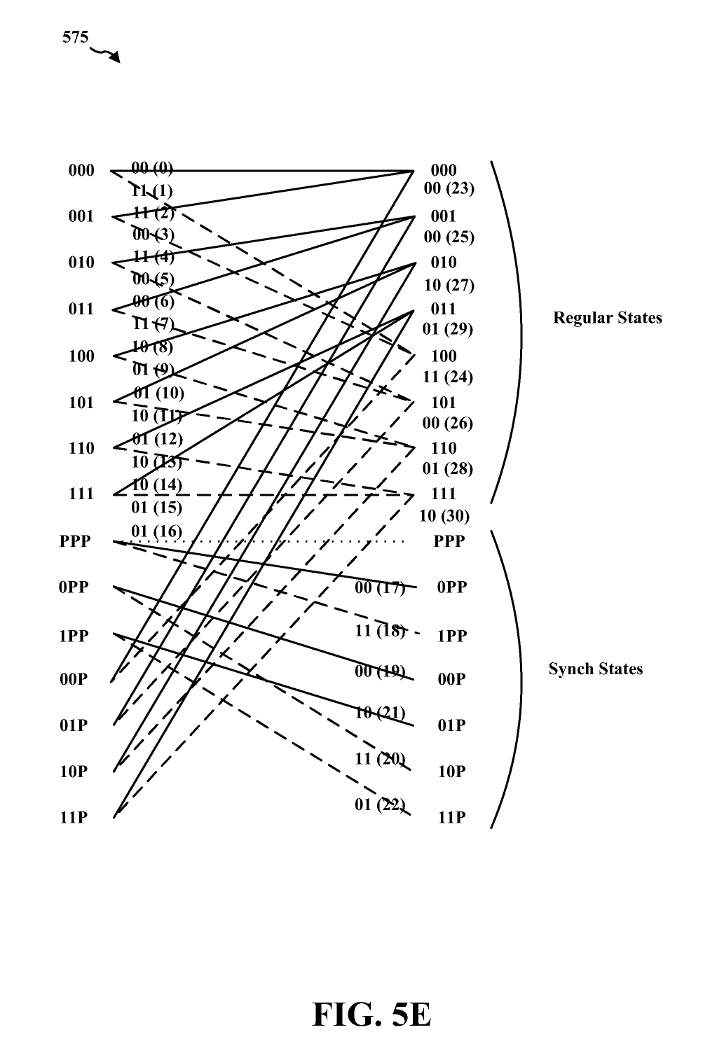

The convolutionally coded data packet 400 may be decoded and synchronization with the transmitting device may be performed at a receiver device, e.g., using the techniques described below in connection with any of FIGS. 5A-8.

In wireless communications, a convolutional code is a type of error-correcting code that may generate parity symbols via a sliding application of a boolean polynomial function to data packet bitstream. The sliding application may represent the “convolution” of the encoder over the data packet, which gives rise to the term “convolutional coding.” The sliding nature of the convolutional codes facilitates trellis decoding using a time-invariant trellis. Time invariant trellis decoding allows convolutional codes to be maximum-likelihood soft-decision decoded with reasonable complexity.

The ability to perform maximum likelihood soft decision decoding with reasonable complexity is one of the major benefits of convolutional codes. This is in contrast to classic block codes, which are generally represented by a time-variant trellis and therefore are typically hard-decision decoded, and hence, use additional processing, time, and power as compared to convolutional codes. Convolutional codes are often characterized by the base code rate and the depth (or memory) of the encoder. The base code rate is typically given as n/k, where n is the input data rate and k is the output symbol rate. The depth is often called the “constraint length” ‘K’, where the output is a function of the current input as well as the previous K−1 inputs. The depth may also be given as the number of memory elements “v” in the polynomial or the maximum possible number of states of the encoder (typically 2^{v}).

Convolutional codes are often described as continuous. However, it may also be said that convolutional codes have arbitrary block length, rather than being continuous, since most real-world convolutional encoding is performed on blocks of data. Convolutionally encoded block codes typically employ termination. The arbitrary block length of convolutional codes can also be contrasted to classic block codes, which generally have fixed block lengths that are determined by algebraic properties.

The code rate of a convolutional code may be modified via symbol puncturing. For example, a convolutional code with a “mother” code rate n/k=1/2 may be punctured to a higher rate of, for example, 7/8 simply by not transmitting a portion of code symbols. The performance of a punctured convolutional code generally scales well with the amount of parity transmitted. The ability to perform reduced-complexity soft decision decoding on convolutional codes, as well as the block length and code rate flexibility of convolutional codes, makes them very useful for short-range communications, e.g., such as BLE.

FIG. 5A illustrates a packet acquisition subsystem 500 that includes a Viterbi Decoder and a more detailed illustration of the Viterbi Decoder 512 in accordance with certain aspects of the disclosure.

The packet acquisition subsystem 500 may include a preamble detector 502 that may receive a convolutionally coded data packet (e.g., such as the convolutionally coded data packet 400 described above in connection with FIG. 4), detect the arrival of preamble as opposed to noise, and determine the reference timing for the demodulator 504.

The demodulator 504 may receive a convolutionally encoded data packet and calculate a soft demodulator output for every encoder output symbol period that may indicate the distance of the received signal of one encoder output symbol period of duration from each of all possible output symbols in the code alphabet.

The symbol detector 506 may convert the soft demodulator output of the demodulator 504 into a hard-decision demodulator output by such as slicing and quantization.

The detected symbol buffer 508 may store the hard-decision demodulator output of the symbol detector 506 in order to provide them to the synchronizer 510.

The synchronizer 510 may compare the hard-decision demodulator outputs stored in the detected symbol buffer 508 with expected values corresponding to a part of preamble and/or a part of the coded access address that the receiver device expects.

FIG. 5B illustrates a trellis diagram 515 associated with a convolutional code used by convolutionally encoded BLE PHY packets in accordance with certain aspects of the disclosure.

Referring to FIG. 5A, the packet acquisition subsystem 500 may include a Viterbi Decoder 512 that uses a Viterbi algorithm in order to decode a data packet that has been encoded using convolutional code. The Viterbi Decoder 512 may include various blocks such as a branch metric unit (BMU) 516, a path metric unit (PMU) 518, and a traceback unit (TBU) 520.

A BMU's 516 function may be to calculate and/or determine branch metrics, which are normed distances between every possible symbol in the code alphabet, and the received symbol from the bitstream of the data packet. In other words, a branch metric may be a measure of distance between the received signal of one encoder input symbol period of duration and the expected signal for each branch in a trellis diagram. Branch metrics may be computed and/or determined as samples are received at the BMU 516.

A Viterbi Decoder 512 (e.g., soft-decision Viterbi Decoder) may receive a bitstream containing information about the reliability of each received symbol. For instance, in a 3-bit encoding, the reliability information can be encoded as seen below in Table 1 if the encoder input is binary symbols, which may be calculated based on the soft demodulator output.

TABLE 1
3-bit encoding reliability information

| | |
|---|---|
| value | meaning |

| | | |
|---|---|---|
| 000 | strongest | 0 |
| 001 | relatively strong | 0 |
| 010 | relatively weak | 0 |
| 011 | weakest | 0 |
| 100 | weakest | 1 |
| 101 | relatively weak | 1 |
| 110 | relatively strong | 1 |
| 111 | strongest | 1 |

A PMU 518 may summarize branch metrics to get metrics for 2^{K-1} paths, where K is the constraint length of the code, one of which can eventually be chosen as optimal. At predetermined intervals, the PMU 518 makes 2^{K-1} decisions, throwing off wittingly non-optimal paths. The results of these decisions may be written to the memory of the TBU 520. Denoting the constraint length of convolutional code by K and the number of bits per input symbol by k, there are 2^{k(K-1)} states and PMUs 518, one PMU 518 for each state, and 2^{k} branches and BMUs 516 per state. For example, the convolutional code used by convolutionally encoded BLE PHY packets uses K=4 and k=1, resulting in 8 states and 16 branches as shown in the trellis diagram 515 illustrated in FIG. 5B. Hence, conventional Viterbi Decoder 512 includes 8 PMUs 518 and 16 BMUs 516. In the trellis diagram 515 illustrated in FIG. 5B, solid lines and dashed lines represent input symbol 0 and 1, respectively, and numbers on each line represent the encoder output symbols with numbers in parentheses indicating branch indices.

The core elements of a PMU 518 may include Add-Compare-Select (ACS) units. The way in which ACS units are connected between themselves may be defined by a specific code's trellis diagram.

Since path metric is stored using a finite number of bits, there must be an additional circuit preventing path metric counters from overflowing. An alternate method that eliminates the need to monitor the path metric growth is to allow the path metrics to “roll over” by ensuring the path metric accumulators contain enough bits to prevent the “best” and “worst” values from coming within 2⁽ⁿ⁻¹⁾ of each other. The compare circuit is essentially unchanged. A path metric may be a measure of distance between the entire received signal and the expected signal for each path, which may be computed and/or determined by accumulating branch metrics generated by BMUs 516 over time in the PMU 518.

The TBU 520 restores a maximum-likelihood path from the decisions made by PMU 518. Since the TBU 520 restores the maximum-likelihood path in inverse direction, a Viterbi decoder may include first-in-last-out (FILO) buffer to reconstruct a correct order. One problem with using the Viterbi Decoder 512 illustrated in FIG. 5A to decode a convolutionally encoded data packet is that the Viterbi Decoder 512 may require knowledge of the beginning of a codeword or convolutionally-encoded block, which is not always available in practice. For example, BLE data packets start with a preamble followed by a convolutionally-encoded block, e.g., as described above in connection with FIG. 4. Because the beginning of the encoded block (e.g., the coded access address 404 and/or the rate indicator 408 in FIG. 4) is not known a priori, the receiver device may need to determine the boundary between the preamble (e.g., preamble 402 in FIG. 4) and the convolutionally-encoded block (e.g., the coded access address 404 and/or the rate indicator 408 in FIG. 4), which may cause certain problems in terms of a performance bottleneck. For example, the receiver device may not reliably detect the boundary if the first symbols of the encoded block resemble the last symbols of preamble, and hence, the misdetection of the boundary may become the performance bottleneck of the receiver device. The first bits of the encoded block may be decoded on a symbol-by-symbol basis or other methods inferior to those employed by a Viterbi Decoder, which may lead to a data packet being dropped or not decoded.

These problems may preclude the use of Viterbi Decoder 512 in the packet acquisition subsystem 500 at the receiver device, which may cause the receiver device to resort to high-complexity low-performance alternatives.

The present disclosure provides a solution to the performance bottleneck caused when the boundary between the preamble and the convolutionally encoded block is not known a priori by removing the symbol detector and synchronizer from the packet acquisition subsystem 500 illustrated in FIG. 5A that create a performance bottleneck and moving the synchronization task to Viterbi Detector, as described below in connection with any of FIGS. 5C-8. The likelihood metric described below in connection with the self-synchronizing Viterbi Decoder in FIGS. 5C-5E may be used instead of a distance metric that is used above to describe the Viterbi Decoder in FIGS. 5A and 5B.

FIG. 5C illustrates a packet acquisition subsystem 545 that includes a self-synchronizing Viterbi Decoder 528 in accordance with certain aspects of the present disclosure.

FIG. 5D illustrates a more detailed illustration of a self-synchronizing Viterbi Decoder 528 in accordance with certain aspects of the disclosure. In certain implementations, the self-synchronizing Viterbi Decoder 528 may be used in the packet acquisition subsystem 545 illustrated in FIG. 5C.

FIG. 5E illustrates a trellis diagram 575 associated with a convolutional code that may be used by convolutionally encoded BLE PHY packets that includes both regular states (e.g., non-synchronization states) and synchronization states in accordance with certain aspects of the disclosure. In certain aspects, regular states may be states in which all memory units in a convolutional encoder (e.g., at the transmitter) are filled with input symbols to be encoded, whereas synchronization states are states where some or all of memory units correspond to preamble period, which are not encoded into the encoded block.

Referring to FIG. 5C, by removing the symbol detector 506 and synchronizer 510 from the packet acquisition subsystem 500 in FIG. 5A that are performance bottlenecks and moving the synchronization task to the Viterbi Detector, the packet acquisition subsystem 545 illustrated in FIG. 5C may reduce the performance bottleneck associated with the packet acquisition subsystem 500. In certain aspects, the preamble detector 524 of the packet acquisition subsystem 545 may detect the preamble at the last symbol of the preamble or prior to the last symbol of the preamble, and send a signal to the demodulator 526 upon detection of the preamble which may contain information regarding the reference timing information for the demodulator 526.

The Viterbi Decoder 528 included in the packet acquisition subsystem 545 may be referred to as a self-synchronizing Viterbi Decoder 528. In other words, the packet acquisition subsystem 545 illustrated in FIG. 5C may not perform synchronization nor symbol decoding based on suboptimal symbol-by-symbol hard-decision symbols, as in the packet acquisition subsystem 500 described above in connection with FIG. 5A.

Instead the packet acquisition subsystem 545 illustrated in FIG. 5C may perform both synchronization and decoding using a self-synchronizing Viterbi Decoder 528 in order to achieve the maximum-likelihood sequence detection with improved performance as compared to the packet acquisition subsystem 500 described above in connection with FIG. 5A.

Because the Viterbi Decoder 528 performs the synchronization task, the associated trellis diagram (e.g., trellis diagram 575 in FIG. 5E) illustrated in FIG. 5E includes extra states (e.g., synchronization states) and branches to handle the preamble period, resulting in the expanded trellis diagram shown in FIG. 5E.

In FIG. 5E, “P” denotes preamble symbols and a dotted line indicates the input symbol is the preamble symbol. If a path starts at PPP (all paths start with PPP)-->PPP-->OPP-->00P-->000-->100, then this path stayed in preamble for one symbol period (because there is only one PPP-->PPP transition), then stayed in encoded block for 4 symbol periods while encoding input symbols 0001. For this example, we say that the path left the preamble 4 symbol periods ago, e.g., elapsed time since leaving preamble is 4.

There are various differences between the Viterbi Decoder 512 described above in connection with FIG. 5A and the self-synchronizing Viterbi Decoder 528 described in connection with FIG. 5D.

First, unlike the Viterbi Decoder 512 described above in connection with FIG. 5A, which initializes the path metric corresponding to the 000 state to, for example, 0 and all other path metrics to the most negative value, the self-synchronizing Viterbi Decoder 528 in FIG. 5D initializes the path metric corresponding to the PPP state to 0 and all other path metrics to the most negative value because it normally starts while in preamble.

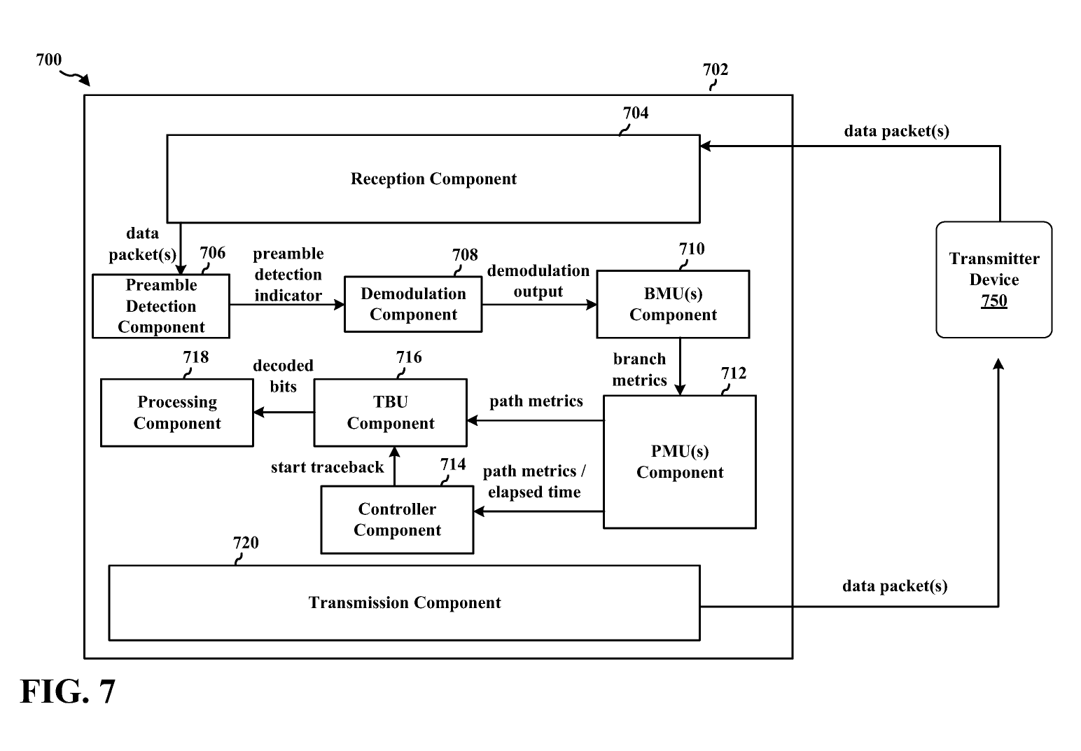

Referring to FIG. 5D, the self-synchronizing Viterbi Decoder 528 may include 16 BMUs 530 (similar to Viberbi Decoder 512 in FIG. 5A) and 15 extra BMUs 532 (as compared to Viterbi Decoder 512 in FIG. 5A) for computing branch metrics for branches 16 to 30 emanating from the synchronization states. The self-synchronizing Viterbi Decoder 528 may include 8 PMUs 540 (similar to Viterbi Decoder 512 in FIG. 5A) and 7 extra PMUs 534 for computing 7 synchronization states. Because all synchronization states have one incoming branch, PMUs 534 for the synchronization states may accumulate branch metrics, not perform comparison and selection. Hence, the PMUs 534 for the synchronization states may be referred to as “mini-PMUs.” PMUs 540 for regular states have three incoming branches each as seen in FIG. 5E, two from regular states and one from the synchronization states. Hence, the comparison logic in a PMU 540, 534 of a self-synchronizing Viterbi Decoder 528 may select the path having the largest path metric out of three candidates.

Each path has the path metric that is computed in PMU 540. If there are 8 non-synchronization states, then there are 8 survivor paths, one path in each state. The control logic may determine which one of the 8 values of the 8 survivor paths is the largest. For example, if the path metrics for state 0, 1, 2, 3, . . . , 7 are respectively 0.2, 0.5, −1.0, 5.3, 0, 0, 0.2, 0.3, then state 3 has the largest path metric 5.3. Then, the control logic 538 may determine when the survivor path that landed in state 3 left the preamble, and if the elapsed time equals the traceback length (e.g., 5(K−1)), the control logic may send a signal to the TBU 536 to start traceback. Traceback may be determined for one selected path (e.g., the path with the largest path metric), and hence, traceback timing may not be determined for each state.

The control logic 538 that determines the traceback start timing of a self-synchronizing Viterbi Decoder 528 may be further elaborated as comparted to the Viterbi Decoder 512. In the Viterbi Decoder 512 illustrated in FIG. 5A, the control logic 522 needs only to count the number of processed input symbols, and start traceback if the count reaches the traceback length. The traceback length associated with Viterbi Decoder 512 may typically be set to 5(K−1) or 5K, because the Viterbi Decoder 512 may initiate operations starting at (or known fixed time after) the beginning of the encoded block.

In contrast, the self-synchronizing Viterbi Decoder 528 may initiate operations at any point during the preamble. The control logic 538 associated with the Viterbi Decoder 528 may determine the traceback timing based on how long ago a synchronization states-to-regular states transition occurred for the survivor path with the largest path metric. Determining a traceback timing may be equivalent to determining a boundary between the preamble and the encoded block. In other words, rather than determining the boundary between the preamble and the encoded block, the Viterbi Decoder 528 may determine a traceback timing in order to decode the data packet without determining the boundary between the preamble (e.g., preamble 402 in FIG. 4) and the convolutionally-encoded block, which may cause certain problems in terms of a performance bottleneck as described above in connection with the Viterbi Decoder 512 in FIG. 5B.

A survivor path may include the most likely path, e.g., the path with the largest path metric, out of all candidate paths that merge at a given state. Thus, each PMU 540 in the Viterbi Decoder 528 for regular states may track how long ago a survivor path left the preamble and remained in the encoded block. In certain aspects, elapse in block[7:0] in FIG. 5D may denote the time. If a path from the synchronization states is selected in the add-compare-select logic in PMU 540 of the Viterbi Decoder 528, the signal may be reset to K−1. If a path from regular states is selected by the Viterbi Decoder 528, the signal is set to the elapse in block of the selected path plus one. If the elapse counter corresponding to the maximum path metric out of 2^{(K-1)} candidates reaches the traceback length, the control logic 538 of the Viterbi Decoder 528 starts traceback.

Using the techniques described above in connection with FIGS. 5C-5E, the receiver device of the present disclosure may determine the traceback timing for the survivor path for each of the plurality of non-synchronization states and for each of the plurality of synchronization states in order to decode the encoded block based on the traceback timing instead of determining a boundary between the preamble and encoded block to decode the data packet. Hence the receiver device of the present disclosure may avoid data packets being dropped and/or not properly decoded. In other words, the packet acquisition subsystem 545 described above in connection with FIG. 5C, may not perform synchronization nor symbol decoding based on suboptimal symbol-by-symbol hard-decision symbols. Instead, the packet acquisition subsystem 545 of the present disclosure may perform both tracing back timing determination and decoding using a self-synchronizing Viterbi Decoder 528 which achieves almost maximum-likelihood sequence detection performance.

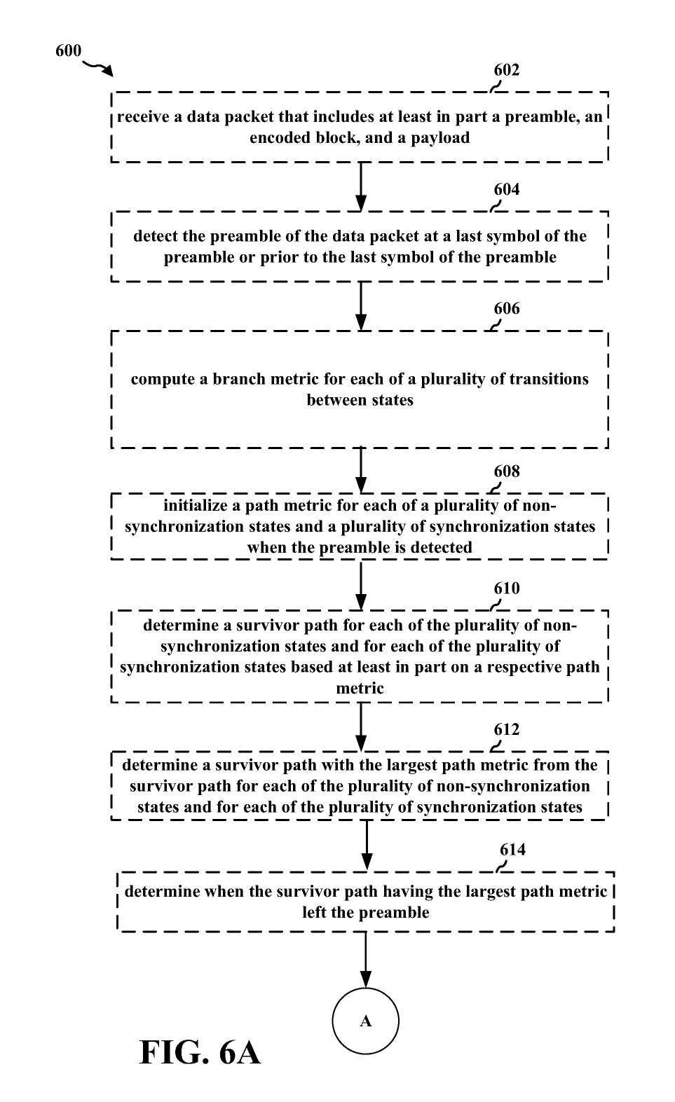

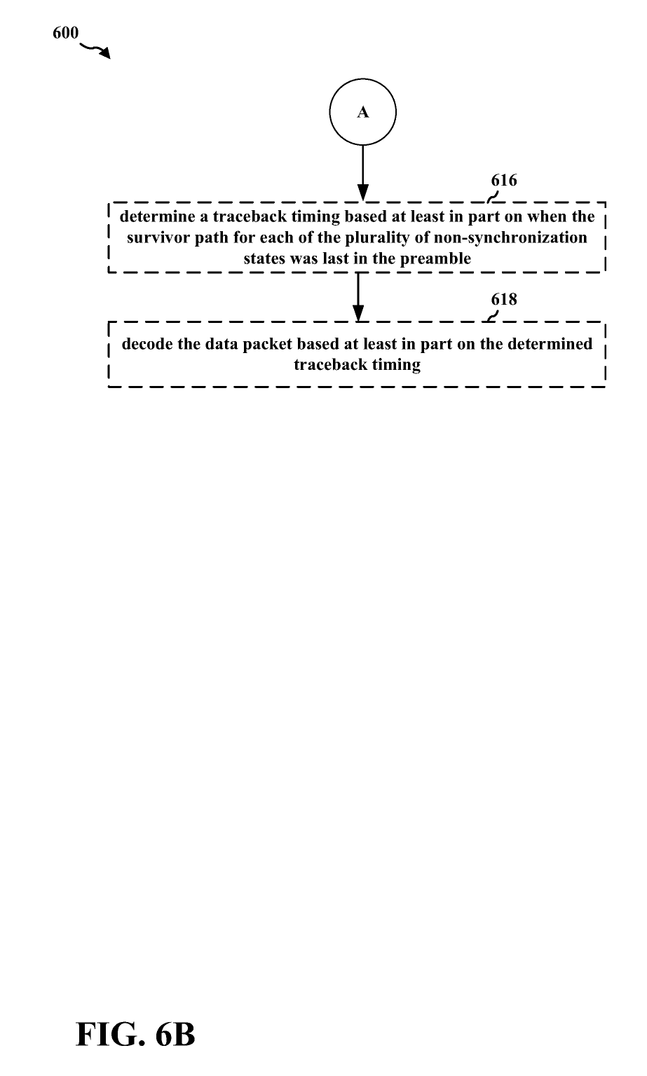

FIGS. 6A and 6B are a flowchart 600 of a method of wireless communication. The method may be performed by a receiver device (e.g., the central device 102, peripheral device 104, 106, 108, 110, 112, wireless device 200, packet acquisition subsystem 545, Viterbi Decoder 528, the apparatus 702/702′). In FIGS. 6A and 6B, optional operations are indicated with dashed lines.

Referring to FIG. 6A, at 602, the receiver device may receive a data packet that includes at least in part a preamble, an encoded block, and a payload. For example, referring to FIGS. 4, 5C, and 5D, a receiver device that includes the packet acquisition subsystem 545 and/or the Viterbi Decoder 528 may receive a data packet 400 that includes a preamble 402, a coded access address 404, a rate indicator 408, a header 410, a payload 412, and a CRC 414. In certain configurations, one or more of the coded access address 404 and/or the rate indicator 408 may be convolutionally coded and be referred to as the “encoded block” of the convolutionally coded data packet 400.

At 604, the receiver device may detect the preamble of the data packet at a last symbol of the preamble or prior to the last symbol of the preamble. For example, referring to FIG. 5C, the preamble detector 524 of the packet acquisition subsystem 545 may detect the preamble at the last symbol of the preamble or prior to the last symbol of the preamble, and send a signal to the demodulator 526 upon detection of the preamble which may contain information regarding the reference timing information for the demodulator 526.

At 606, the receiver device may compute a branch metric for each of a plurality of transitions between states. For example, referring to FIGS. 5D and 5E, the self-synchronizing Viterbi Decoder 528 may include 15 extra BMUs 532 (as compared to Viterbi Decoder 512) for computing branch metrics for branches 16 to 30 emanating from the synchronization states, and 16 BMUs 530 for computing branch metrics for branches 0-15 emanating from the regular states.

At 608, the receiver device may initialize a path metric for each of a plurality of non-synchronization states and a plurality of synchronization states when the preamble is detected, each of the plurality of synchronization states being associated with the preamble. For example, referring to FIGS. 5D and 5E, the self-synchronizing Viterbi Decoder 528 in FIG. 5D initializes the path metric corresponding to the PPP state to 0 and all other path metrics (e.g., path metrics for non-synchronization states and non-PPP synchronization states) to the most negative value because it normally starts while in preamble.

At 610, the receiver device may determine a survivor path for each of the plurality of non-synchronization states and for each of the plurality of synchronization states based at least in part on a respective path metric. For example, referring to FIGS. 5D and 5E, each path has the path metric that is computed in PMU 540. If there are 8 non-synchronization states, then there are 8 survivor paths, one path in each state.

At 612, the receiver device may determine a survivor path with the largest path metric from the survivor path for each of the plurality of non-synchronization states and for each of the plurality of synchronization states. For example, referring to FIGS. 5D and 5E, the control logic 538 may determine which one of the 8 values of the 8 survivor paths is the largest. For example, if the path metrics for state 0, 1, 2, 3, . . . , 7 are respectively 0.2, 0.5, −1.0, 5.3, 0, 0, 0.2, 0.3, then state 3 has the largest path metric 5.3.

At 614, the receiver device may determine when the survivor path having the largest path metric left the preamble. For example, referring to FIGS. 5D and 5E, the control logic 538 may determine when the survivor path that landed in state 3 left the preamble.

Referring to FIG. 6B, at 616, the receiver device may determine a traceback timing based at least in part on when the survivor path for each of the plurality of non-synchronization states was last in the preamble. For example, referring to FIGS. 5D and 5E, the control logic may determine when the survivor path that landed in state 3 left the preamble, and if the elapsed time equals the traceback length (e.g., 5(K−1), the control logic 538 may send a signal to the TBU 536 to start traceback. Traceback may be determined for one selected path (e.g., the path with the largest path metric), and hence, traceback timing may not be determined for each state.

At 618, the receiver device may decode the data packet based at least in part on the determined traceback timing. For example, referring to FIGS. 5D and 5E, the Viterbi Decoder 528 may decode the encoded block based on the traceback timing instead of based on a determination of the boundary between the preamble and encoded block.

FIG. 7 is a conceptual data flow diagram 700 illustrating the data flow between different means/components in an exemplary apparatus 702. The apparatus may be a receiver device (e.g., the central device 102, peripheral device 104, 106, 108, 110, 112, wireless device 200, packet acquisition subsystem 545, Viterbi Decoder 528, the apparatus 702/702′) in communication with a transmitter device 750 (e.g., the central device 102, peripheral device 104, 106, 108, 110, 112, wireless device 200). The apparatus may include a reception component 704, a preamble detection component 706, a demodulation component 708, a BMU(s) component 710, a PMU(s) component 712, a controller component 714, a TBU component 716, a processing component 718, and a transmission component 720.

The reception component 704 may be configured to receive a data packet that includes at least in part a preamble, an encoded block, and a payload. The reception component 704 may be configured to send the data packet to the preamble detection component 706.

The preamble detection component 706 may be configured to detect the preamble of the data packet at a last symbol of the preamble or prior to the last symbol of the preamble. The preamble detection component 706 may be configured to send a signal to the demodulation component 708 upon detection of the preamble which may contain information regarding the reference timing information for the demodulation component 708.

The demodulation component 708 may be configured to demodulate the signal associated with the data packet, and configured to send the demodulated output to the BMU(s) component 710.

The BMU(s) component 710 may be configured to compute a branch metric for each of a plurality of transitions between states. The BMU(s) component 710 may be configured to send a signal associated with the computed branch metric for each of the plurality of transitions between states to the PMU(s) component 712.

The PMU(s) component 712 may be configured to initialize a path metric for each of a plurality of non-synchronization states and a plurality of synchronization states when the preamble is detected, each of the plurality of synchronization states being associated with the preamble. The PMU(s) component 712 may be configured to send a signal associated with the path metrics and/or branch decisions and/or the elapsed time to one or more of the controller component 714 and/or the TBU component 716.

The PMU component 712 may be configured to determine a survivor path for each of the plurality of non-synchronization states and for each of the plurality of synchronization states based at least in part on a respective path metric. The controller component 714 may be configured to determine a survivor path with the largest path metric from the survivor path for each of the plurality of non-synchronization states and for each of the plurality of synchronization states. The controller component 714 may be configured to determine when the survivor path having the largest path metric left the preamble. Upon determining when the survivor path having the largest path metric left the preamble, the controller component 714 may be configured to send a signal instructing the TBU component 716 to start traceback.

The TBU component 716 may be configured to determine a traceback timing based at least in part on when the survivor path for each of the plurality of non-synchronization states was last in the preamble. In certain aspects, the TBU component 716 may be configured to initiate the traceback timing determination upon determining when the largest path metric survivor path left the preamble from the controller component 714. The TBU component 716 may be configured to decode the data packet based at least in part on the determined traceback timing. The TBU component 716 may send the decoded bits of the data packet to the processing component 718 for processing.

The transmission component 720 may be configured to send data packet(s) to the transmitter device 750.

The apparatus may include additional components that perform each of the blocks of the algorithm in the aforementioned flowcharts of FIGS. 6A and 6B. As such, each block in the aforementioned flowcharts of FIGS. 6A and 6B may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

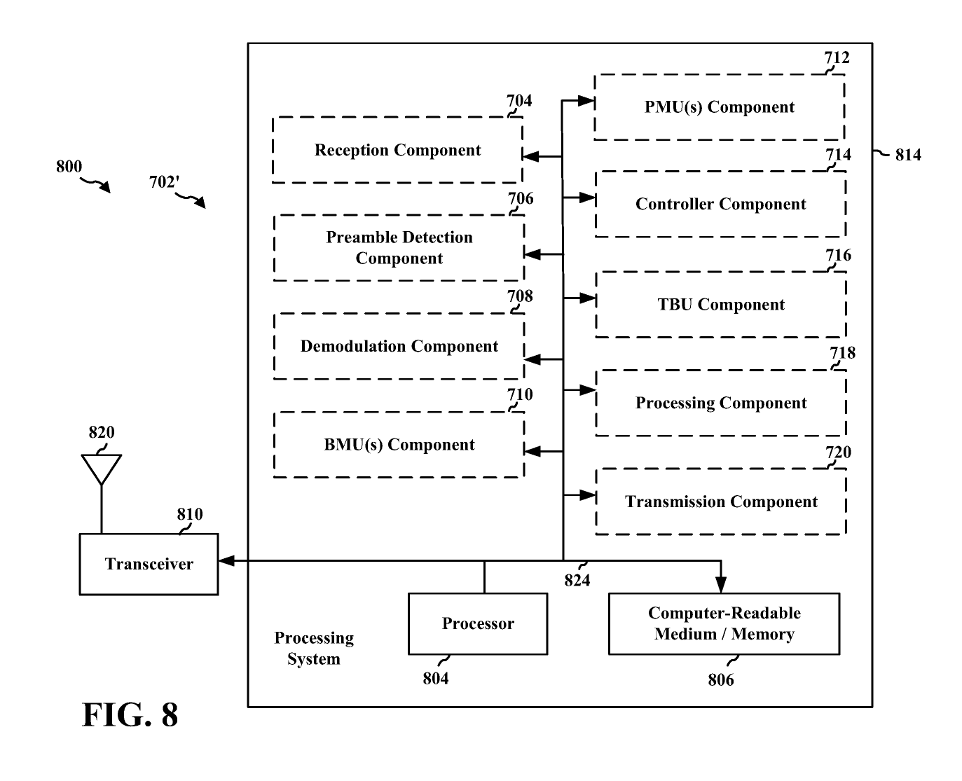

FIG. 8 is a diagram 800 illustrating an example of a hardware implementation for an apparatus 702′ employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware components, represented by the processor 804, the components 704, 706, 708, 710, 712, 714, 716, 718, 720 and the computer-readable medium/memory 806. The bus 824 may also link various other circuits such as timing sources, peripherals, voltage regulators, and power management circuits, which are well known in the art, and therefore, will not be described any further.

The processing system 814 may be coupled to a transceiver 810. The transceiver 810 is coupled to one or more antennas 820. The transceiver 810 provides a means for communicating with various other apparatus over a transmission medium. The transceiver 810 receives a signal from the one or more antennas 820, extracts information from the received signal, and provides the extracted information to the processing system 814, specifically the reception component 704. In addition, the transceiver 810 receives information from the processing system 814, specifically the transmission component 720, and based on the received information, generates a signal to be applied to the one or more antennas 820. The processing system 814 includes a processor 804 coupled to a computer-readable medium/memory 806. The processor 804 is responsible for general processing, including the execution of software stored on the computer-readable medium/memory 806. The software, when executed by the processor 804, causes the processing system 814 to perform the various functions described supra for any particular apparatus. The computer-readable medium/memory 806 may also be used for storing data that is manipulated by the processor 804 when executing software. The processing system 814 further includes at least one of the components 704, 706, 708, 710, 712, 714, 716, 718, 720. The components may be software components running in the processor 804, resident/stored in the computer readable medium/memory 806, one or more hardware components coupled to the processor 804, or some combination thereof.

In certain configurations, the apparatus 702/702′ for wireless communication may include means for receiving a data packet that includes at least in part a preamble, an encoded block, and a payload. In certain other configurations, the apparatus 702/702′ for wireless communication may include means for detect the preamble of the data packet at a last symbol of the preamble or prior to the last symbol of the preamble. In certain other configurations, the apparatus 702/702′ for wireless communication may include means for computing a branch metric for each of a plurality of transitions between states. In certain other configurations, the apparatus 702/702′ for wireless communication may include means for initializing a path metric for each of a plurality of non-synchronization states and a plurality of synchronization states when the preamble is detected. In certain aspects, each of the plurality of synchronization states may be associated with the preamble. In certain other configurations, the apparatus 702/702′ for wireless communication may include means for determining a survivor path for each of the plurality of non-synchronization states and for each of the plurality of synchronization states based at least in part on a respective path metric. In certain other configurations, the apparatus 702/702′ for wireless communication may include means for determining a survivor path with the largest path metric from the survivor path for each of the plurality of non-synchronization states and for each of the plurality of synchronization states. In certain other configurations, the apparatus 702/702′ for wireless communication may include means for determining when the survivor path having the largest path metric left the preamble. In certain other configurations, the apparatus 702/702′ for wireless communication may include means for determining a traceback timing based at least in part on when the survivor path for each of the plurality of non-synchronization states was last in the preamble. In certain aspects, the means for determining the traceback timing may be configured to initiate the traceback timing determination upon determining when the largest path metric survivor path left the preamble. In certain other configurations, the apparatus 702/702′ for wireless communication may include means for decode the data packet based at least in part on the determined traceback timing. The aforementioned means may be the processor(s) 202, the radio 230, the MMU 240, short-range communication controller 252, one or more of the aforementioned components of the apparatus 702 and/or the processing system 814 of the apparatus 702′ configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication, comprising:
receiving a data packet that includes at least in part a preamble, an encoded block, and a payload;
detecting the preamble of the data packet at a last symbol of the preamble or prior to the last symbol of the preamble;
computing a branch metric for each of a plurality of transitions between states;
initializing a path metric for each of a plurality of non-synchronization states and a plurality of synchronization states, each of the plurality of synchronization states being associated with the preamble;
determining a survivor path for each of the plurality of non-synchronization states and for each of the plurality of synchronization states based at least in part on a respective path metric; and
determining a traceback timing based at least in part on when the survivor path for each of the plurality of non-synchronization states was last in the preamble.

2. The method of claim 1, further comprising:
determining a survivor path having the largest path metric from the survivor path for each of the plurality of non-synchronization states and for each of the plurality of synchronization states; and
determining when the survivor path having the largest path metric left the preamble.

3. The method of claim 2, wherein the determining the traceback timing is initiated upon determining when the largest path metric survivor path left the preamble.

4. The method of claim 1, further comprising:
decoding the data packet based at least in part on the determined traceback timing.

5. An apparatus for wireless communication, comprising:
means for receiving a data packet that includes at least in part a preamble, an encoded block, and a payload;
means for detecting the preamble of the data packet at a last symbol of the preamble or prior to the last symbol of the preamble;
means for computing a branch metric for each of a plurality of transitions between states;
means for initializing a path metric for each of a plurality of non-synchronization states and a plurality of synchronization states, each of the plurality of synchronization states being associated with the preamble;
means for determining a survivor path for each of the plurality of non-synchronization states and for each of the plurality of synchronization states based at least in part on a respective path metric; and
means for determining a traceback timing based at least in part on when the survivor path for each of the plurality of non-synchronization states was last in the preamble.

6. The apparatus of claim 5, further comprising:
means for determining a survivor path having the largest path metric from the survivor path for each of the plurality of non-synchronization states and for each of the plurality of synchronization states; and
means for determining when the survivor path having the largest path metric left the preamble.

7. The apparatus of claim 6, wherein the means for determining the traceback timing is configured to initiate the traceback timing determination upon determining when the largest path metric survivor path left the preamble.

8. The apparatus of claim 5, further comprising:
means for decoding the data packet based at least in part on the determined traceback timing.

9. An apparatus for wireless communication, comprising:
a memory; and
at least one processor coupled to the memory and configured to:
receive a data packet that includes at least in part a preamble, an encoded block, and a payload;
detect the preamble of the data packet at a last symbol of the preamble or prior to the last symbol of the preamble;
compute a branch metric for each of a plurality of transitions between states;
initialize a path metric for each of a plurality of non-synchronization states and a plurality of synchronization states, each of the plurality of synchronization states being associated with the preamble;
determine a survivor path for each of the plurality of non-synchronization states and for each of the plurality of synchronization states based at least in part on a respective path metric; and
determine a traceback timing based at least in part on when the survivor path for each of the plurality of non-synchronization states was last in the preamble.

10. The apparatus of claim 9, wherein the at least one processor is further configured to:
determine a survivor path having the largest path metric from the survivor path for each of the plurality of non-synchronization states and for each of the plurality of synchronization states; and
determine when the survivor path having the largest path metric left the preamble.

11. The apparatus of claim 10, wherein the at least one processor is configured to determine the traceback timing upon determining when the largest path metric survivor path left the preamble.

12. The apparatus of claim 9, wherein the at least one processor is further configured to:
decode the data packet based at least in part on the determined traceback timing.

13. A computer-readable medium storing computer executable code, comprising code to:
receive a data packet that includes at least in part a preamble, an encoded block, and a payload
detect the preamble of the data packet at a last symbol of the preamble or prior to the last symbol of the preamble;
compute a branch metric for each of a plurality of transitions between states;
initialize a path metric for each of a plurality of non-synchronization states and a plurality of synchronization states when the preamble is detected, each of the plurality of synchronization states being associated with the preamble;
determine a survivor path for each of the plurality of non-synchronization states and for each of the plurality of synchronization states based at least in part on a respective path metric; and
determine a traceback timing based at least in part on when the survivor path for each of the plurality of non-synchronization states was last in the preamble.

14. The computer-readable medium of claim 13, further comprising code to:
determine a survivor path having the largest path metric from the survivor path for each of the plurality of non-synchronization states and for each of the plurality of synchronization states; and
determine when the survivor path having the largest path metric left the preamble.

15. The computer-readable medium of claim 14, wherein the code to determine the traceback timing is initiated upon determining when the largest path metric survivor path left the preamble.

16. The computer-readable medium of claim 13, further comprising code to:
decode the data packet based at least in part on the determined traceback timing.
